(19) United States
(12) Patent Application Publication
(10) Pub. No.: US 2011/0027661 A1
(43) Pub. Date: Feb. 3, 2011

(54) ELECTRODE ELEMENT, METHOD OF MANUFACTURING ELECTRODE ELEMENT, AND LITHIUM ION SECONDARY BATTERY

(75) Inventors: Sanae Okazaki, Sunto-gun (JP); Yasushi Tsuchida, Susono-shi (JP); Phyllis Xu, Cambridge, MA (US); Kazunori Takada, Tsukuba-shi (JP)

Correspondence Address: OLIFF & BERRIDGE, PLC, P.O. BOX 320850, ALEXANDRIA, VA, 22320-4850, US

(73) Assignees: Toyota Jidosha Kabushiki Kaisha, Toyota-shi (JP); National Institute For Material Science, Tsukuba-shi (JP)

(21) Appl. No.: 12/866,111

(22) PCT Filed: Feb. 17, 2009
(86) PCT No.: PCT/IB09/00279

§ 371 Date: Oct. 14, 2010

(30) Foreign Application Priority Data
Feb. 18, 2008 (JP) 2008-036537

(51) Int. Cl. H01M 10/0562; H01M 4/24; H01M 4/26

(52) U.S. Cl. 429/322; 429/209; 29/623.5

(57) ABSTRACT

An electrode element contains a positive electrode active material and a second solid electrolyte. The positive electrode active material has an active material and a first solid electrolyte. Seventy percent or more of a surface of the active material is coated with the first solid electrolyte.

### BACKGROUND OF THE INVENTION

1. Field of the Invention

The invention relates to an electrode element that contains an active material and a solid electrolyte, a method of manufacturing the electrode element, and a lithium ion secondary battery provided with the electrode element.

2. Description of the Related Art

A lithium ion secondary battery has a higher energy density than other secondary batteries and is able to operate at a high voltage. Thus, the lithium ion secondary battery has been used in information devices, such as cellular phones, as a secondary battery because of its easily reduced size and weight. In recent years, the lithium ion secondary battery is in increasing demand for use in hybrid vehicles, or the like, as a large power source.

The lithium ion secondary battery includes a positive electrode layer, a negative electrode layer and an electrolyte arranged, between the layers. The electrolyte is made of a nonaqueous liquid or a solid. When the electrolyte is made of a nonaqueous liquid (hereinafter, referred to as “electrolyte solution”), the electrolyte solution permeates into the positive electrode layer. Thus, it is easy to form an interface between a positive electrode active material of the positive electrode layer and the electrolyte, and it is easy to improve the performance. However, because a widely used electrolyte solution is flammable, it is necessary to equip a system for ensuring safety. On the other hand, because a solid electrolyte is nonflammable, it is possible to simplify the safety system. For the above reasons, a lithium ion secondary battery provided with a nonflammable solid electrolyte (hereinafter, referred to as “solid electrolyte layer” where appropriate) has been suggested.

In the lithium ion secondary battery in which the solid electrolyte layer is arranged between the positive electrode layer and the negative electrode layer (hereinafter, referred to as “pressed-powder all-solid battery” where appropriate), the positive electrode active material and the electrolyte are solid. Thus, it is difficult for the electrolyte to permeate into the positive electrode active material, and it is difficult to form an interface between the positive electrode active material and the electrolyte. Therefore, in the pressed-powder all-solid battery, a positive electrode mixture layer that includes a mixture of the positive electrode active material powder and the solid electrolyte powder is used as the positive electrode layer to increase the area of the interface.

In addition, in the pressed-powder all-solid battery, a resistance against movement of lithium ions across the interface between the positive electrode active material and the electrolyte (hereinafter, referred to as “interface resistance” where appropriate) tends to increase. This is because the positive electrode active material reacts with the solid electrolyte to form a high-resistance portion on the surface of the positive electrode active material (see Electrochemistry Communications, 9 (2007), pages 1486 to 1490). There is a correlation between the interface resistance and the performance of the pressed-powder all-solid battery, so techniques for improving the performance of the pressed-powder all-solid battery by reducing the interface resistance have been disclosed so far. For example, the above Electrochemistry Communications describes a technique for reducing the interface resistance in such a manner that the surface of a lithium cobaltate is coated with a lithium niobate to form a positive electrode active material.

In addition, Japanese Patent Application Publication No. 2001-52733 (JP-A-2001-52733) describes a technique related to a pressed-powder all-solid battery in which at least portion of the surface of a positive electrode active material made of a lithium-containing transition metal oxide supports a lithium chloride. Moreover, Japanese Patent Application Publication No. 2001-6674 (JP-A-2001-6674) describes a technique related to a pressed-powder all-solid battery in which at least one of the electrode layers uses an electron-lithium ion mixed conductor. Furthermore, Japanese Patent Application Publication No. 2004-175609 (JP-A-2004-175609) describes a technique related to a lithium ion battery that includes a positive electrode containing a modified lithium cobaltate in which a metal oxide adheres on the surface of a lithium cobaltate particle.

With the technique described in the Electrochemistry Communications, it is conceivable that the interface resistance may be reduced by coating the surface of a lithium cobaltate with a lithium niobate. However, when the surface-coated positive electrode active material is mixed with the solid electrolyte in order to manufacture the positive electrode mixture layer of the pressed-powder all-solid battery, the surface coating of the positive electrode active material easily peels off, causing a problem that the effect of reducing the interface resistance tends to be impaired. Even when the technique described in the Electrochemistry Communications is combined with the techniques described in JP-A-2001-52733, JP-A-2001-6674 and JP-A-2004-175609, it is still difficult to solve the above problem.

### SUMMARY OF THE INVENTION

The invention provides an electrode element that is able to reduce the interface resistance, a method of manufacturing the electrode element, and a lithium ion secondary battery provided with the electrode element.

A first aspect of the invention provides an electrode element. The electrode element includes: a positive electrode active material that includes an active material and a first solid electrolyte with which 70 percent or more of a surface of the active material is coated; and a second solid electrolyte.

In the first aspect, the phrase “positive electrode active material that includes an active material and a first solid electrolyte with which 70 percent or more of a surface of the active material is coated” means that the positive electrode active material at least includes the active material and the first solid electrolyte as components, and 70 percent or more of the surface of the active material is coated with the first solid electrolyte. Here, the ratio (hereinafter, referred to as “coverage”) of the surface of the active material, coated with a layer (hereinafter, referred to as “coating layer” where appropriate) that contains the first solid electrolyte, may be derived by a method, such as microscope image (image of a scanning electron microscope (hereinafter, referred to as “SEM”) or a transmission electron microscope) analysis using a difference in contrast due to a structural difference between the active material and the coating layer. Other than that, when there are an element only contained in the active material and an element only contained in the first solid electrolyte, the coverage may be derived from the results of ultimate analysis of X-ray photoelectron spectroscopy (hereinafter, referred to as “XPS”) analysis. In addition, the “active material” is not specifically limited as long as the “active material” is a material that may be used as the positive electrode active material of a lithium ion secondary battery, and, when the material forms a positive electrode layer of the lithium ion secondary battery together with the second solid electrolyte with no coating layer formed thereon, the material reacts with the second solid electrolyte to form a high-resistance portion at least at an interface between the material and the second solid electrolyte. Here, the “high-resistance portion” means a portion which is formed on the surface of the active material when the active material contacts the second solid electrolyte to react with each other, and at which a resistance against movement of lithium ions is higher than that of the inside of the active material or the second solid electrolyte. In addition, in the first aspect, the “coated” means that a state where the first solid electrolyte is arranged on the surface of the active material in a non-flowable manner is maintained. Furthermore, in the first aspect, it is only necessary that the coating layer, with which the surface of the active material is coated, has lithium ion conductivity and contains a material (first solid electrolyte) that is able to maintain the form of the coating layer that does not flow even when brought into contact with the second solid electrolyte. Here, the phrase “coating layer has lithium ion conductivity” means that the coating layer has lithium ion conductivity such that the lithium ion conducting resistance between the positive electrode active material and the second solid electrolyte is at least lower than the lithium ion conducting resistance between the active material and the second solid electrolyte when the surface of the active material is not coated with the first solid electrolyte. Furthermore, the “second solid electrolyte” means a solid electrolyte that forms the positive electrode layer together with the positive electrode active material. The “second solid electrolyte” is not specifically limited as long as the “second solid electrolyte” is a solid electrolyte that, when no coating layer is formed on the surface of the active material, reacts with the active material to form a high-resistance portion on the surface of the active material and that may be used in the positive electrode layer of the pressed-powder all-solid battery.

With the first aspect, the surface of the active material is coated with the first solid electrolyte. Thus, it is possible to provide an electrode element that is able to reduce the interface resistance.

In the first aspect, the electrode element may further include a conductive agent.

The “conductive agent” means a conductive material that is contained in the electrode element in order to, for example, improve electron conductivity of the electrode element. The “conductive agent” is not specifically limited as long as it is a material that may be used in the positive electrode layer of the pressed-powder all-solid battery.

With the first aspect, the electrode element further includes the conductive agent. Thus, it is possible to provide an electrode element that is additionally able to improve electron conductivity.

In addition, in the first aspect, the first solid electrolyte may be a lithium niobate, and the second solid electrolyte may be a sulfide.

In the first aspect, the first solid electrolyte is a lithium niobate, and the second solid electrolyte is a sulfide. Thus, it is possible to provide an electrode element that is able to reduce the interface resistance.

A second aspect of the invention provides a method of manufacturing an electrode element. The method includes: preparing a positive electrode active material by forming a coating layer containing a first solid electrolyte on a surface of an active material; and mixing the positive electrode active material, on which the coating layer is formed, with a second solid electrolyte so as to maintain a state where the coating layer is arranged on 70 percent or more of a surface of the positive electrode active material.

In the second aspect, the “preparing a positive electrode active material” is not specifically limited as long as the non-flowable coating layer that contains the first solid electrolyte may be formed on the surface of the active material, and it may be a known method. In addition, in the second aspect, the “mixing” is not specifically limited as long as at least the positive electrode active material and the second solid electrolyte may be uniformly mixed with each other, and a state where 70 percent or more of the surface of the active material that forms the uniformly mixed positive electrode active material together with the second solid electrolyte is coated with the coating layer may be maintained, and it may be a known method.

With the second aspect, the electrode element that contains the positive electrode active material, in which 70 percent or more of the surface of the active material is coated with the coating layer, may be manufactured. Thus, it is possible to provide a method of manufacturing an electrode element, by which an electrode element that is able to reduce the interface resistance may be manufactured.

In the second aspect, the method may further include preparing a mixture by mixing a conductive agent with the second solid electrolyte before mixing the positive electrode active material, on which the coating layer is formed, with the second solid electrolyte, and the prepared mixture may be mixed with the positive electrode active material on which the coating layer is formed.

In the second aspect, the mixture is prepared by mixing the conductive agent with the second solid electrolyte before mixing the positive electrode active material with the second solid electrolyte. Thus, it is possible to provide a method of manufacturing an electrode element, by which an electrode element that is additionally able to improve electron conductivity may be manufactured.

In addition, in the second aspect, the first solid electrolyte may be a lithium niobate, and the second solid electrolyte may be a sulfide.

In the second aspect, the first solid electrolyte is a lithium niobate, and the second solid electrolyte is a sulfide. Thus, it is possible to provide a method of manufacturing an electrode element, by which an electrode element that is able to reduce the interface resistance may be manufactured.

A third aspect of the invention provides a lithium ion secondary battery. The lithium ion secondary battery includes: a positive electrode layer that contains the electrode element according to the first aspect; a negative electrode layer; and a solid electrolyte layer that is arranged between the positive electrode layer and the negative electrode layer.

With the third aspect, the positive electrode layer includes the electrode element according to the first aspect. Thus, it is possible to provide a lithium ion secondary battery that is able to improve the performance by reducing the interface resistance.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a conceptual view that shows an example of a positive electrode mixture layer;

FIG. 2 is a flowchart that shows an example of a method of manufacturing an electrode element according to an embodiment of the invention;

FIG. 3 is a conceptual view that shows an example of a cell provided in a secondary battery;

FIG. 4 is a conceptual view of a Cole-Cole plot;

FIG. 5 is a graph that shows the relationship between an interface resistance and a coverage;

FIG. 6A to FIG. 6D are views that show the results of ultimate analysis;

FIG. 7A to FIG. 7D are views that show the results of observation by SEM;

FIG. 8A and FIG. 8B are views that show the results of observation by SEM;

FIG. 9A and FIG. 9B are views that show the results of observation by SEM; and

FIG. 10 is a graph that shows the results of discharge capacities.

### DETAILED DESCRIPTION OF EMBODIMENTS

A powdery positive electrode active material and a powdery solid electrolyte are used in a pressed-powder all-solid battery. Therefore, in an existing art, when a positive electrode layer that contains a solid electrolyte and a positive electrode active material coated with a coating layer is manufactured, the positive electrode active material and the solid electrolyte are uniformly mixed using a mortar to prepare powder elements, and the powder elements are applied onto a current collector and then dried, for example. However, the inventors have found that, when the positive electrode active material and the solid electrolyte are mixed using a mortar, a shear force applied to the surface of the positive electrode active material causes the coating layer to peel off and, as a result, the effect of reducing the interface resistance tends to be impaired. To increase the interface between the positive electrode active material and the solid electrolyte, it is effective to uniformly mix the positive electrode active material with the solid electrolyte. A mixing method using a mortar is widely known as a method for uniformly mixing two or more kinds of powder materials. However, even when the interface is increased by uniformly mixing the positive electrode active material with the solid electrolyte, if the coating layer formed on the surface of the positive electrode active material peels off, a high-resistance portion is formed on the surface of the positive electrode active material to increase the interface resistance. Thus, the performance of the resultant pressed-powder all-solid battery decreases. For this reason, to improve the performance of the pressed-powder all-solid battery, it should be considered to manufacture the positive electrode layer by uniformly mixing the positive electrode active material with the solid electrolyte while suppressing peeling of the coating layer.

A first aspect of an embodiment of the invention provides an electrode element that is able to reduce the interface resistance by suppressing peeling of the coating layer formed on the surface of the positive electrode active material. In addition, a second aspect of the embodiment of the invention provides a method of manufacturing an electrode element that is able to reduce the interface resistance by suppressing peeling of the coating layer formed on the surface of the positive electrode active material. Moreover, a third aspect of the embodiment of the invention provides a lithium ion secondary battery (pressed-powder all-solid battery) provided with a positive electrode layer for which peeling of the coating layer formed on the surface of the positive electrode active material is suppressed, which is able to reduce the interface resistance.

Hereinafter, the present embodiment will be specifically described with reference to the accompanying drawings.

### 1. Electrode Element (Positive Electrode Mixture Layer)

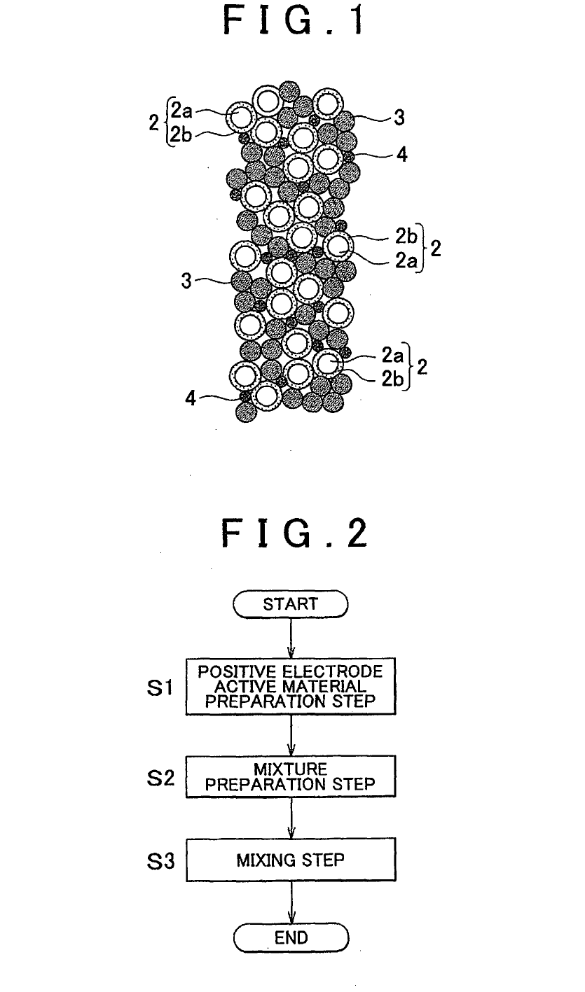

FIG. 1 is a conceptual view that shows an example of an electrode element (hereinafter, referred to as “positive electrode mixture layer” where appropriate) according to the present embodiment. As shown in FIG. 1, the positive electrode mixture layer 1 according to the present embodiment contains positive electrode active materials 2, solid electrolytes 3, and conductive agents 4, and these are uniformly mixed. Each of the positive electrode active materials 2 has an active material 2a that is predominantly composed of LiCoO₂ and a coating layer 2b formed on the surface of the active material 2a. Each coating layer 2b is predominantly composed of LiNbO₃. On the other hand, each of the solid electrolytes 3 is composed of Li₇P₃S₁₁, and each of the conductive agents 4 is composed of vapor-grown carbon fiber.

In the positive electrode mixture layer 1, as the active materials 2a and the solid electrolytes 3 contact to react with each other, high-resistance portions are formed on the surfaces of the active materials 2a. When the high-resistance portions are formed on the surfaces of the active materials 2a, lithium ions are hard to move. As a result, the performance of the pressed-powder all-solid battery having the positive electrode mixture layer 1 decreases. To suppress the above situation, in the positive electrode mixture layer 1, the coating layer 2b is arranged on 70 percent or more of the surface of each active material 2a, and the thus formed positive electrode active materials 2 are mixed with the solid electrolytes 3. The coating layers 2b are arranged respectively on the surfaces of the active materials 2a to place the coating layers 2b between the active materials 2a and the solid electrolytes 3. Thus, reaction between the active materials 2a and the solid electrolytes 3 is suppressed and, therefore, it is possible to suppress formation of the high-resistance portions. Hence, with the positive electrode mixture layer 1 according to the present embodiment, it is possible to reduce the interface resistance.

Note that the positive electrode mixture layer 1 may be, for example, manufactured in the following processes. First, the coating layers 2b are respectively formed on the surfaces of the active materials 2a to prepare the positive electrode active materials 2. After that, the positive electrode active materials 2, the solid electrolytes 3 and the conductive agents 4 are mixed together to form mixed powder elements. Then, binding agents are added to the mixed powder elements to prepare a mixture. Finally, the mixture is applied and then dried. The detail of the manufacturing process will be described later.

### 2. Method of Manufacturing Electrode Element

FIG. 2 is a flowchart that shows an example of a method of manufacturing an electrode element according to the embodiment. Hereinafter, the method of manufacturing an electrode element according to the present embodiment will be described with reference to FIG. 1 and FIG. 2. As shown in FIG. 2, the method of manufacturing an electrode element according to the present embodiment includes a positive electrode active material preparation step (step S1), a mixture preparation step (step S2) and a mixing step (step S3).

### 2.1. Positive Electrode Active Material Preparation Step (Step S1)

In step S1, the coating layers 2b are respectively formed on the surfaces of the active materials 2a to prepare the positive electrode active materials 2. In step S1, for example, equimolar LiOC₂H₅ and Nb(OC₂H₅)₅ are dissolved in a solvent (for example, ethanol) to prepare a composition, and the composition is sprayed to coat the surfaces of LiCoO₂ using a roll and flow coating machine. The spray-coated LiCoO₂ is subjected to heat treatment. Thus, the coating layers 2b (LiNbO₃) are formed on the surfaces of the active materials 2a (LiCoO₂). In this manner, the positive electrode active materials 2 are prepared. Note that the step S1 is not limited to the above embodiment, another method may be employed as long as the coating layers 2b may be formed on the surfaces of the active materials 2a.

### 2.2. Mixture Preparation Step (Step S2)

In step S2, the solid electrolytes 3 are mixed with the conductive agents 4 to prepare a mixture of the solid electrolytes 3 and the conductive agents 4. The step S2 is not specifically limited to the above embodiment as long as the solid electrolytes 3 may be mixed with the conductive agents 4. For example, the step S2 may be a step in which the solid electrolytes 3 are uniformly mixed with the conductive agents 4 using a mortar.

### 2.3. Mixing Step (Step S3)

In step S3, the positive electrode active materials 2 prepared in step S1 are mixed with the mixture prepared in step S2 so as to maintain a state where the coating layers 2b are arranged respectively on 70 percent or more of the surfaces of the positive electrode active materials 2. When a shear force is applied to the coating layers 2b while the positive electrode active materials 2 respectively having the coating layers 2b are mixed with the mixture, the coating layers 2b coating the surfaces of the active materials 2a tend to peel off. For this reason, in step S3, while maintaining a state where a shear force applied to each of the coating layers 2b is lower than or equal to a predetermined value (for example, 10 N or below), the positive electrode active materials 2 are uniformly mixed with the mixture. The step S3 is not specifically limited to the above described method as long as, for example, the positive electrode active materials 2 may be uniformly mixed with the mixture at a shear force of 10 N or below. For example, the step S3 may be a step in which the positive electrode active materials 2 are mixed with the mixture using a spatula, or may be a step in which the positive electrode active materials 2 may be mixed with the mixture using a shaker.

Furthermore, in step S3, even when a shear force applied to each of the coating layers 2b is maintained at a predetermined value or below, if the positive electrode active materials 2 are not uniformly mixed with the mixture, contact interfaces between the positive electrode active materials 2 and the solid electrolytes 3 are reduced. This decreases lithium ion conductivity and electron conductivity in the positive electrode mixture layer 1 and, as a result, the performance of the positive electrode mixture layer 1 decreases. Thus, in step S3, the positive electrode active materials 2 are uniformly mixed with the mixture. Whether the positive electrode active materials 2 and the mixture are uniformly mixed may be, for example, determined whether R2≦3×R1 is satisfied where the diameter of each positive electrode active material particle 2 is R1 and the diameter of each agglomerate of the positive electrode active material particles 2 contained in the powder elements mixed in step S3 is R2.

In this way, with the method of manufacturing an electrode element, which has steps S1 to S3, according to the present embodiment, the coating layers 2b are respectively arranged on 70 percent of the surfaces of the positive electrode active materials 2, and the thus formed positive electrode active materials 2, the solid electrolytes 3 and the conductive agents 4 may be uniformly mixed to prepare powder elements. Thus, the positive electrode mixture layer 1 may be manufactured in such a manner that a binding agent is added to the powder elements to prepare a mixture and then the mixture is applied and dried. The positive electrode active materials 2, in which the coating layers 2b are respectively arranged on 70 percent of the surfaces thereof, are contained in the positive electrode mixture layer 1. Thus, according to the present embodiment, it is possible to provide a method of manufacturing an electrode element, by which the electrode element (positive electrode mixture layer 1) that is able to reduce the interface resistance may be manufactured.

### 3. Lithium Ion Secondary Battery

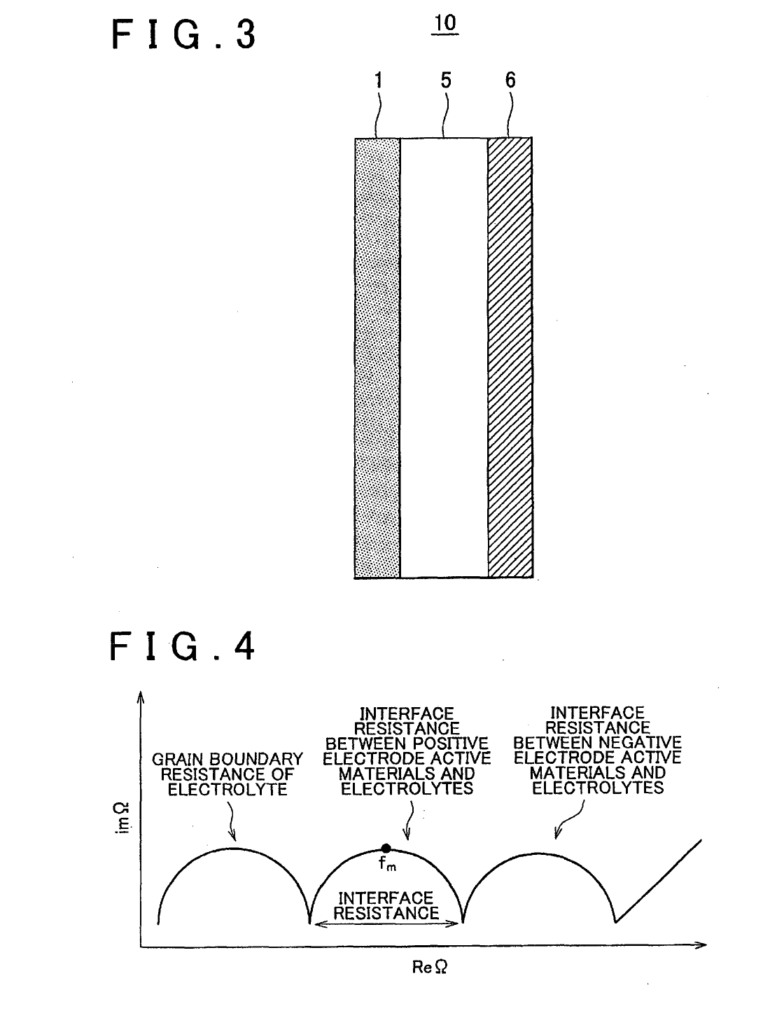

FIG. 3 is a conceptual view that shows an example of a cell provided in a lithium ion secondary battery according to the present embodiment. In FIG. 3, like reference numerals denote like components to those used in FIG. 1, and the description thereof is omitted where appropriate. In addition, FIG. 3 simply shows the configuration of the positive electrode layer. Hereinafter, the lithium ion secondary battery according to the present embodiment will be described with reference to FIG. 1 and FIG. 3.

As shown in FIG. 3, the lithium ion secondary battery 10 (hereinafter, referred to as “secondary battery 10”) according to the present embodiment includes a positive electrode layer (hereinafter, referred to as “positive electrode layer 1” where appropriate) formed of the positive electrode mixture layer 1, a solid electrolyte layer 5 containing Li₇P₃S₁₁, and a negative electrode layer 6 formed of an indium foil. During charging the secondary battery 10, lithium ions are drawn from the active materials 2a that constitute the positive electrode active materials 2 of the positive electrode layer 1, and conducted through the coating layers 2b, the solid electrolytes 3 and the solid electrolyte layer 5 to the negative electrode layer 6. In contrast, during discharging the secondary battery 10, lithium ions discharged from the negative electrode layer 6 are conducted through the solid electrolyte layer 5, the solid electrolytes 3 and the coating layers 2b to the active materials 2a. In this way, during charging and discharging the secondary battery 10, lithium ions move across the interfaces between the positive electrode active materials 2 and the solid electrolytes 3. Therefore, to achieve the high-capacity and high-power secondary battery 10, it should be considered to reduce the resistance of the interface (interface resistance). Here, the secondary battery 10 includes the positive electrode mixture layer 1. The positive electrode mixture layer 1 contains the positive electrode active materials 2 in which the coating layers 2b are arranged respectively on 70 percent of the surfaces of the active materials 2a. The coating layers 2b are placed between the active materials 2a and the solid electrolytes 3 to make it possible to suppress occurrence of reaction between the active materials 2a and the solid electrolytes 3. As a result, it is possible to suppress formation of high-resistance portions on the surfaces of the active materials 2a. That is, the secondary battery 10 includes the positive electrode layer 1 that is able to reduce the interface resistance. According to the present embodiment, it is possible to provide the secondary battery 10 that is able to improve the performance by reducing the interface resistance.

In the above description related to the electrode element, the method of manufacturing an electrode element and the lithium ion secondary battery according to the present embodiment, the electrode element and the lithium ion secondary battery each contain the conductive agents 4, and the method of manufacturing an electrode element includes the mixture preparation step S2. The aspects of the invention are not limited to these embodiments. It is applicable that the electrode element or the lithium ion secondary battery contains no conductive agent, or it is also applicable that the method of manufacturing the electrode element does not include the mixture preparation step S2. The positive electrode active materials 2 contained in the positive electrode mixture layer 1 have electron conductivity. Thus, even when the electrode element has no conductive agent 4, it is possible to develop electron conductivity. However, in terms of making it easy to improve electron conductivity of the electrode element, it is desirable that the electrode element and the lithium ion secondary battery each contain the conductive agents, and it is also desirable that the method of manufacturing an electrode element includes the mixture preparation step.

In addition, in the above description related to the present embodiment, the active materials 2a that are predominantly composed of LiCoO₂ are contained; however, the aspects of the invention are not limited to this configuration. The active materials according to the aspects of the invention may employ materials that may be used as the positive electrode active materials of the lithium ion secondary battery, and, when the materials form the positive electrode mixture layer together with the solid electrolytes with no coating layer formed thereon, the materials react with the solid electrolytes that constitute the positive electrode mixture layer to form high-resistance portions at least at the interfaces between the materials and the solid electrolytes. A specific example of the active materials usable in the aspects of the invention may be LiNiO₂, LiNi_{1/3}Co_{1/3}Mn_{1/3}O₂, LiMn₂O₄, LiFePO₄, or the like, other than LiCoO₂.

In addition, in the description related to the present embodiment, the coating layers 2b that are predominantly composed of LiNbO₃ are contained; however, the aspects of the invention are not limited to this configuration. It is only necessary that the coating layers in the aspects of the invention have lithium ion conductivity and contain materials (first solid electrolytes) that are able to maintain the form of the coating layers that do not flow even when brought into contact with the active materials or second solid electrolytes. A specific example of the first solid electrolytes that constitute the coating layers may be Li₄Ti₅O₁₂, or the like, other than LiNbO₃.

In addition, in the description related to the present embodiment, the solid electrolytes 3 made of Li₇P₃S₁₁ are contained; however, the aspects of the invention are not limited to this configuration. The solid electrolytes (second solid electrolytes) according to the aspects of the invention are not specifically limited as long as the solid electrolytes react with the active materials which are not coated with the coating layers to form high-resistance portions and may be used in the positive electrode layer of the pressed-powder all-solid battery. A specific example of the second solid electrolytes according to the aspects of the invention may be 80Li₂S-20P₂S₅, Li₃PO₄—Li₂S—SiS₂, Li_{3.25}Ge_{0.25}P_{0.75}O₄, or the like, other than Li₇P₃S₁₁.

In addition, in the above description related to the present embodiment, the conductive agents 4 composed of vapor-grown carbon fiber are contained. However, the aspects of the invention are not limited to this configuration. When the electrode element and the lithium ion secondary battery according to the aspects of the invention each contain the conductive agents and the method of manufacturing an electrode element according to the aspects of the invention includes the mixture preparation step, the conductive agents are not specifically limited as long as the conductive agents are conductive materials that are usable in the positive electrode layer of the pressed-powder all-solid battery. A specific example of the conductive agent according to the aspects of the invention may be acetylene black, Ketjen black, graphite, or the like, other than vapor-grown carbon fiber.

In addition, in the description related to the present embodiment, the secondary battery 10 includes the solid electrolyte layer 5 that contains Li₇P₃S₁₁; however, the aspects of the invention are not limited to this configuration. It is only necessary that the solid electrolyte layer provided in the lithium ion secondary battery according to the aspects of the invention is formed of a material that can function as the solid electrolyte layer of the pressed-powder all-solid battery. A specific example of the material that constitutes the solid electrolyte layer of the lithium ion secondary battery according to the aspects of the invention may be 80Li₂S-20P₂S₅, Li₃PO₄—Li₂S—SiS₂, Li_{3.25}Ge_{0.25}P_{0.75}O₄, or the like, other than Li₇P₃S₁₁.

In addition, in the description related to the present embodiment, the secondary battery 10 includes the negative electrode layer 6 formed of an indium foil; however, the aspects of the invention are not limited to this configuration. It is only necessary that the negative electrode layer provided in the lithium ion secondary battery according to the aspects of the invention is made of a material that can function as the negative electrode layer of the pressed-powder all-solid battery. A specific example of the material that constitutes the negative electrode layer of the lithium ion secondary battery according to the aspects of the invention may be graphite, Sn, Si, Li₄Ti₅O₁₂, Al, Fe₂S, or the like, other than indium.

In addition, in the aspects of the invention, the coverage is not specifically limited as long as the coverage is higher than or equal to 70 percent, and it is easier to obtain the advantageous effects of the aspects of the invention as the coverage is close to 100 percent. The desirable coverage in the aspects of the invention is higher than or equal to 75 percent and lower than or equal to 100 percent.

In addition, in the aspects of the invention, the size of each agglomerate of the positive electrode active materials contained in the electrode element, the lithium ion secondary battery and the powder elements prepared in the mixing step in the method of manufacturing an electrode element desirably satisfies the above described relationship (R2≦3×R1). Furthermore, it is desirable to satisfy R4≦3×R3 where the diameter of each of the solid electrolyte particles mixed with the positive electrode active materials is R3 and the diameter of each of the agglomerates of the solid electrolyte particles mixed with the positive electrode active materials is R4. Specifically, it is desirable to satisfy that R2<35 [μm] and R4<35 [μm].

### 1. Relationship Between Coverage and Interface Resistance

### 1.1. Manufacturing Secondary Battery

### First Example

Equimolar LiOC₂H₅ and Nb(OC₂H₅)₅ were dissolved in the ethanol solvent to prepare a composition, and the composition was sprayed to coat the surfaces of LiCoO₂ using a roll and flow coating machine (SFD-01 produced by Powrex Corporation). After that, the coated LiCoO₂ was subjected to heat treatment at a temperature of 400° C. in the atmospheric pressure for 30 minutes to form LiNbO₃ layers (coating layers) on the surfaces of LiCoO₂ (active materials), thus preparing the positive electrode active materials (having a mean particle diameter of 10 μm, and the same applies to the following positive electrode active materials). Subsequently, the prepared positive electrode active materials and the solid electrolytes (Li₇P₃S₁₁, a mean particle diameter of 7 μm, and the same applies to the following solid electrolytes) were placed in a screw bottle, and mixed over 10 seconds using a shaker (TTM-1 produced by Shibata Scientific Technology, Ltd.) to prepare powder elements (hereinafter, referred to as “powder elements of the first example” where appropriate). The thus prepared powder elements were used to prepare the positive electrode layer 1, and then the secondary battery 10 (hereinafter, referred to as “battery of the first example”) provided with the cell shown in FIG. 3 was manufactured.

### Second Example

The prepared positive electrode active materials and the solid electrolytes were mixed over five minutes using a spatula to prepare powder elements (hereinafter, referred to as “powder elements of the second example”), and, other than that, similar manufacturing steps and materials to those of the battery of the first example were used to manufacture the battery of the second example.

### First Comparative Example

The prepared positive electrode active materials and the solid electrolytes were mixed over five minutes using a mortar to prepare powder elements (hereinafter, referred to as “powder elements of the first comparative example”), and, other than that, similar manufacturing steps and materials to those of the battery of the first example were used to manufacture the battery of the first comparative example.

### 1.2. Measurement of Interface Resistance

The battery of the first example, the battery of the second example and the battery of the first comparative example were charged to 3.58 V at a constant current of 127 μA and then the impedance of each battery after charging was measured by alternating-current impedance method. In the impedance measurement, the interface resistance is expressed by the size of a circular arc in Cole-Cole plot. In addition, from the frequency at the wave crest of each circular arc, the capacitance C may be obtained using the following mathematical expression.

2πfₘ=1/RC

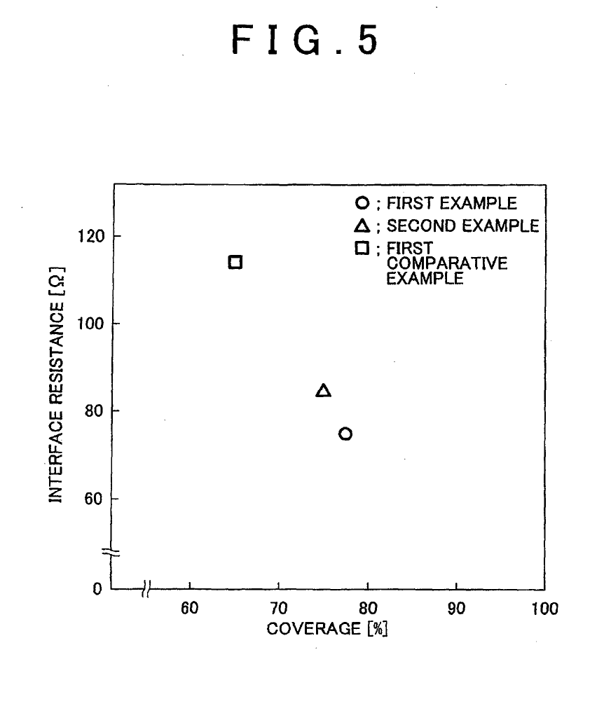

Here, fₘ denotes a frequency at the wave crest, R denotes an interface resistance, and C denotes a capacitance. FIG. 4 shows a conceptual view of the Cole-Cole plot. In the material system used in the battery of the first example, the battery of the second example and the battery of the first comparative example, the resistance of the interface (interface resistance) between the positive electrode active materials and the solid electrolytes was calculated from the diameter of a circular arc corresponding to the capacitance C of about 5×10⁻⁵ [F]. FIG. 5 shows the results.

### 1.3. Derivation of Coverage

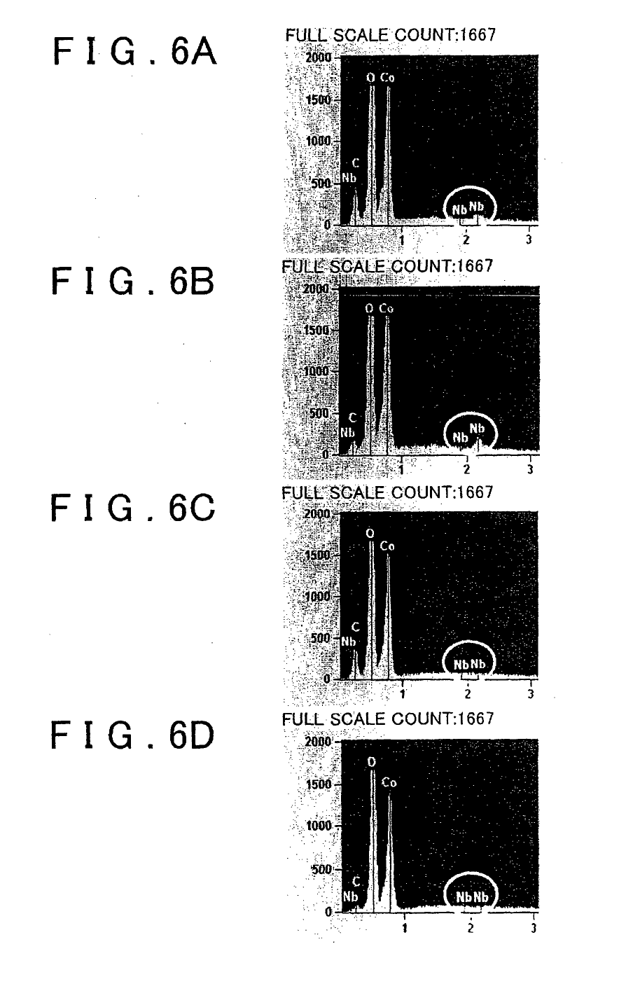

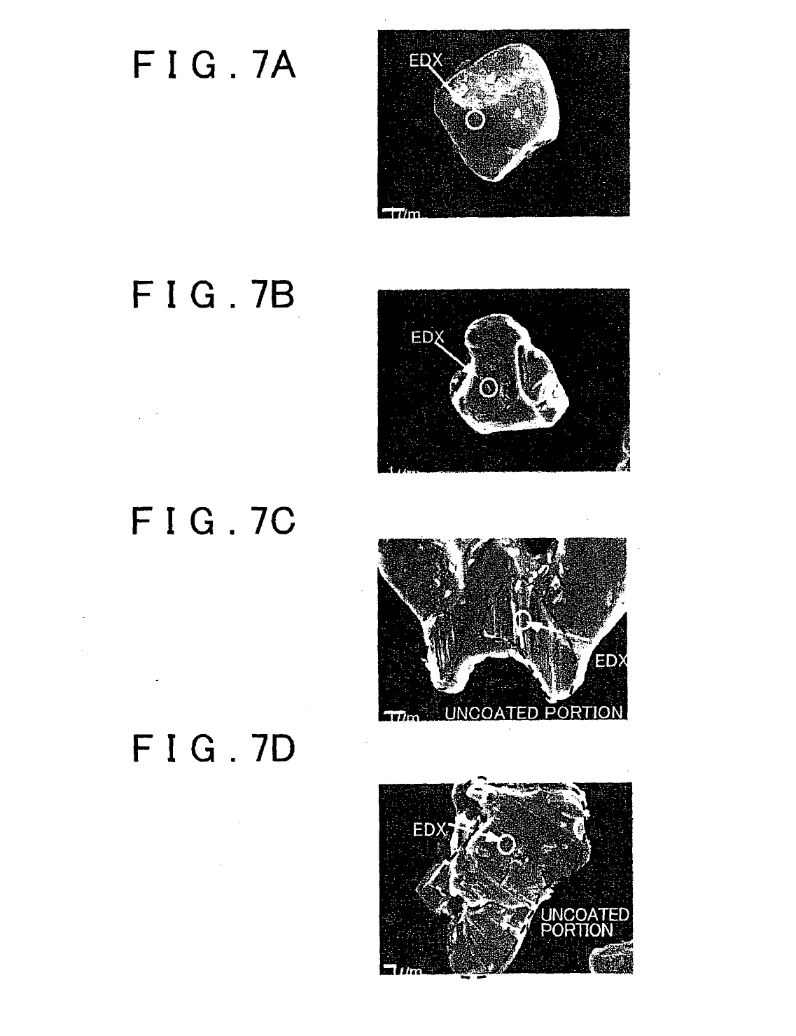

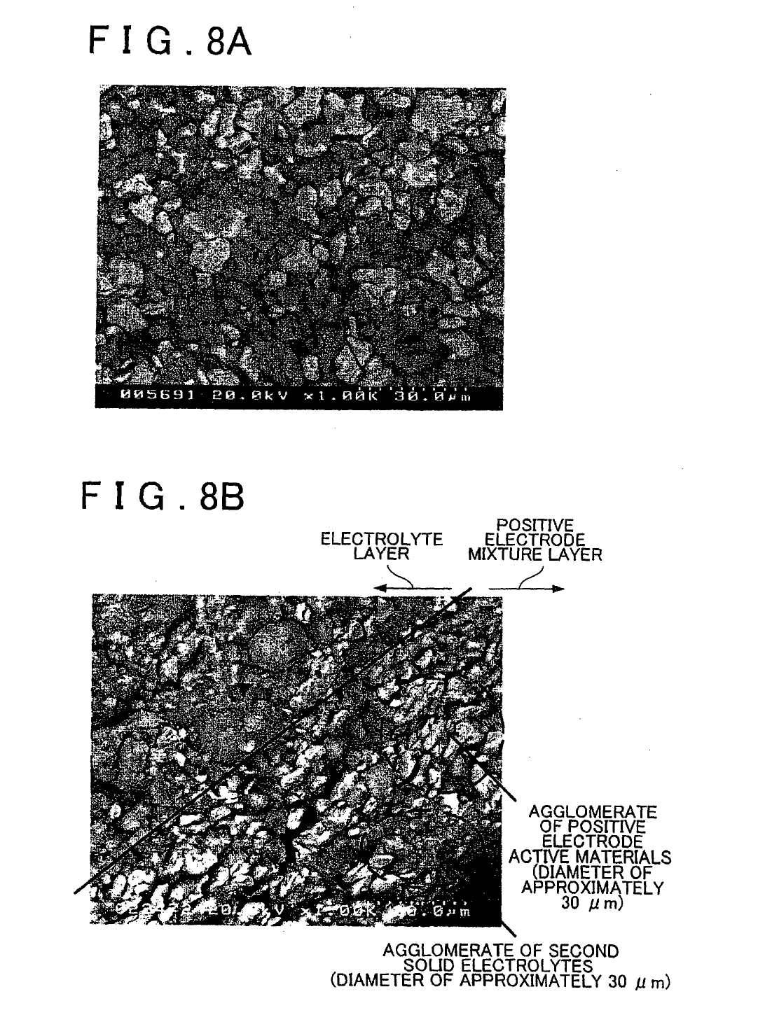

Using XPS, ultimate analysis was conducted on the powder elements of the first example, the powder elements of the second example and the powder elements of the first comparative example (hereinafter, referred to as “respective powder elements”), and the ratio of concentration (Nb/(Nb+Co)) of the element (Nb) only contained in the coating layers to the element (Co) only contained in the active materials was calculated and centupled to derive the coverages of the positive electrode active materials contained in the respective powder elements. FIG. 5 shows the results. At the same time, the powder elements of the first example, the powder elements of the second example and the powder elements of the first comparative example were observed using SEM, and the form of peeling of the coating layer was checked. In addition, the powder elements of the first example and the powder elements of the second example were observed using SEM to check the form of agglomeration of the positive electrode active materials and the form of agglomeration of the solid electrolytes. FIG. 6A to FIG. 6B show the results of ultimate analysis. FIG. 7A to FIG. 7D, FIG. 8A and FIG. 8B show the results of SEM observation. Here, FIG. 6A shows the results of ultimate analysis of the positive electrode active materials before being mixed with the solid electrolytes. FIG. 6B shows the results of ultimate analysis of the positive electrode active materials contained in the powder elements of the first example. FIG. 6C shows the results of ultimate analysis of the positive electrode active materials contained in the powder elements of the second example. FIG. 6D shows the results of ultimate analysis of the positive electrode active materials contained in the powder elements of the first comparative example. In addition, FIG. 7A shows the SEM observation photograph of the positive electrode active material before being mixed with the solid electrolytes. FIG. 7B shows the SEM observation photograph of the positive electrode active material contained in the powder elements of the first example. FIG. 7C shows the SEM observation photograph of the positive electrode active material contained in the powder elements of the second example. FIG. 7D shows the SEM observation photograph of the positive electrode active material contained in the powder elements of the first comparative example. Portions surrounded by the dotted line in FIG. 7C and in FIG. 7D indicate the portions from which the coating layers were peeled off. Furthermore, FIG. 8A shows the SEM observation photograph of the powder elements of the first example. FIG. 8B shows the SEM observation photograph of the powder elements of the second example.

### 1.4. Results

From FIG. 5, the positive electrode active materials contained in the powder elements of the first comparative example, prepared by mixing using a mortar, had the coverage of 64 percent, which is lower than 70 percent, and the interface resistance between the positive electrode active materials and the solid electrolytes, contained in the powder elements of the first comparative example, was 114Ω. In contrast, the positive electrode active materials contained in the powder elements of the first example, prepared by mixing using a shaker, had the coverage of 77 percent, which is higher than or equal to 70 percent, and the interface resistance between the positive electrode active materials and the solid electrolytes, contained in the powder elements of the first example, was 76Ω. In addition, the positive electrode active materials contained in the powder elements of the second example, prepared by mixing using a spatula, had the coverage of 75 percent, which is higher than or equal to 70 percent, and the interface resistance between the positive electrode active materials and the solid electrolytes, contained in the powder elements of the second example, was 85Ω. That is, the positive electrode active materials are prepared by mixing with the solid electrolytes while reducing a shear force applied to the coating layers, so it is possible to maintain the coverage of each positive electrode active material at 70 percent. With the configuration that the positive electrode active materials, of which the coverage is maintained at 70 percent or more, are contained, the interface resistance was able to be reduced. From the above, according to the aspects of the invention, it is possible to provide an electrode element that is able to reduce the interface resistance, a method of manufacturing an electrode element, and a lithium ion secondary battery provided with the electrode element.

In addition, from FIG. 7A, FIG. 7C and FIG. 7D, almost no peeling of the coating layer was observed from the positive electrode active material before mixing (see FIG. 7A), and small-area peeling of the coating layer was observed from the positive electrode active material after being mixed by a mixing method that reduces a shear force (see FIG. 7C). In contrast, large-area peeling of the coating layer was observed from the positive electrode active material after being mixed using a mortar as in the existing manner (see FIG. 7D). Thus, it was confirmed that it is possible to reduce peeling of the coating layers by reducing a shear force applied to the coating layers.

In addition, from FIG. 8A, the powder elements of the first example, prepared by mixing using a shaker, included the agglomerate of the positive electrode active materials having a diameter of about 15 μm and the agglomerate of the solid electrolytes having a diameter of about 15 μm. Furthermore, from FIG. 8B, the powder elements of the second example, prepared by mixing using a spatula, included the agglomerate of the positive electrode active material having a diameter of about 30 μm and the agglomerate of the solid electrolyte having a diameter of about 30 μm. From the above, by preparing the powder elements using a shaker, the positive electrode active materials and the solid electrolytes, which maintain the coverage of 70 percent or more, were able to be mixed further uniformly. That is, the mixing method using a shaker is further desirable.

### 2. Relationship Between Manufacturing Method and Discharge Capacity

### 2.1. Manufacturing Secondary Battery

### Third Example

1.5-mg conductive agents (vapor-grown carbon fiber, and the same applies to the following conductive agents) and 5.3-mg solid electrolytes were mixed using a mortar to prepare a mixture, 0.8-mg positive electrode active materials, prepared by a similar method to that when preparing the powder elements of the first example, and the mixture were placed in a screw bottle, and mixed over 10 seconds using a shaker to prepare powder elements (hereinafter, referred to as “powder elements of the third example”). Then, the powder elements of the third example were used to prepare the positive electrode layer, and, other than that, the secondary battery (hereinafter, referred to as “battery of the third example”) was manufactured as in the case of the battery of the first example (hereinafter, referred to as “battery of the third example”).

### Fourth Example

0.8-mg positive electrode active materials, prepared by a similar method to that when preparing the powder elements of the first example, 5.3-mg solid electrolytes and 1.5-mg conductive agents were placed in a screw bottle, and mixed over five minutes using a shaker to prepare powder elements (hereinafter, referred to as “powder elements of the fourth example”). Then, the powder elements of the fourth example were used to prepare the positive electrode layer, and, other than that, the secondary battery (hereinafter, referred to as “battery of the fourth example”) was manufactured as in the case of the battery of the first example (hereinafter, referred to as “battery of the fourth example”).

### 2.2. SEM Observation

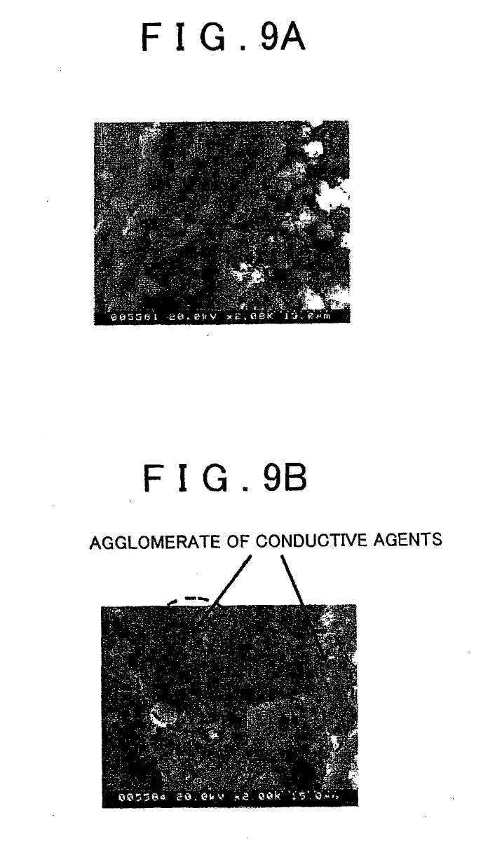

Using SEM, the constitution of the powder elements of the third example and the constitution of the powder elements of the fourth example were observed. FIG. 9A and FIG. 9B show the results. FIG. 9A shows the SEM image of the powder elements of the third example. FIG. 9B shows the SEM image of the powder elements of the fourth example.

### 2.3. Measurement of Discharge Capacity

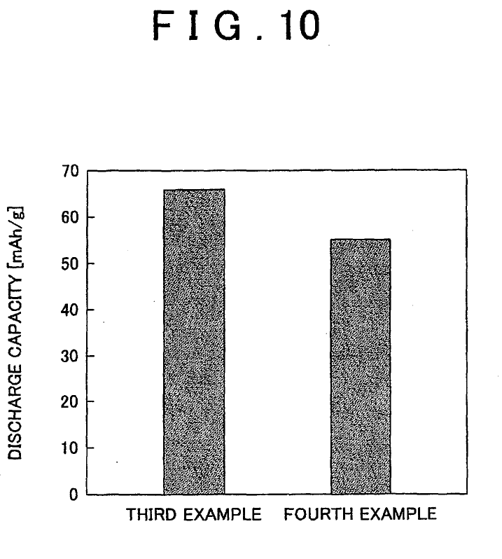

The battery of the third example and the battery of the fourth example were used to charge and discharge at a current of 0.1 C and a cut voltage of 2 V to 3.58 V, and then the discharge capacity was measured. FIG. 10 shows the results.

### 2.4. Results

From FIG. 9A and FIG. 9B, the powder elements of the third example, mixed with the positive electrode active materials after mixing the conductive agents and the solid electrolytes using a mortar, had more uniformly distributed conductive agents. Then, the battery of the third example having the powder elements of the third example had an increased discharge capacity as compared with the battery of the fourth example having the powder elements of the fourth example of which the conductive agents are less uniformly dispersed as compared with the powder elements of the third example. From the above, it was confirmed that, when the positive electrode layer contains the conductive agents, the conductive agents are mixed with the solid electrolytes before mixing the positive electrode active materials with the solid electrolytes, thus making it possible to improve the performance of the battery.

1. An electrode element for a lithium-ion secondary battery comprising:
a positive electrode active material that includes an active material and a first solid electrolyte with which 70 percent or more of a surface of the active material is coated, wherein an agglomerate of the positive electrode active material has a diameter equal to or smaller than 30 μm; and
a second solid electrolyte,
wherein
the electrode element is produced by mixing the positive electrode active material and the second solid electrolyte at a shear force of 10 N or below;
the first solid electrolyte is a material that has lithium ion conductivity and is able to maintain a form of a coating layer that does not flow even when brought into contact with the active material or the second solid electrolyte; and
the second solid electrolyte is an electrolyte that, when no coating layer is formed on the surface of the active material, reacts with the active material to form a high-resistance portion on the surface of the active material and that may be used in a positive electrode layer of a pressed-powder all-solid battery, the high-resistance portion having a higher lithium ion conducting resistance than either of a lithium ion conducting resistance that an inside of the active material has and a lithium ion conducting resistance that the second solid electrolyte has.

2. The electrode element according to claim 1, wherein 75 percent or more and 100 percent or less of the surface of the active material is coated with the first solid electrolyte.

3. (canceled)

4. The electrode element according to claim 1, further comprising:
a conductive agent.

5. The electrode element according to claim 1, wherein the first solid electrolyte is a lithium niobate, and the second solid electrolyte is a sulfide.

6. A method of manufacturing an electrode element for a lithium-ion secondary battery, comprising:
preparing a positive electrode active material by forming a coating layer, containing a first solid electrolyte, on a surface of an active material, wherein an aggregate of the positive electrode active material has a diameter equal to or smaller than 30 μm; and
mixing the positive electrode active material, on which the coating layer is formed, with a second solid electrolyte at a shear force of 10 N or below so as to maintain a state where the coating layer is arranged on 70 percent or more of a surface of the positive electrode active material,
wherein: the first solid electrolyte is a material that has lithium ion conductivity and is able to maintain a form of a coating layer that does not flow even when brought into contact with the active material or the second solid electrolyte; and
the second solid electrolyte is an electrolyte that, when no coating layer is formed on the surface of the active material, reacts with the active material to form a high-resistance portion on the surface of the active material and that may be used in a positive electrode layer of a pressed-powder all-solid battery, the high-resistance portion having a higher lithium ion conducting resistance than either of a lithium ion conducting resistance that an inside of the active material has and a lithium ion conducting resistance that the second solid electrolyte has.

7. (canceled)

8. (canceled)

9. The method of manufacturing an electrode element according to claim 6, wherein the positive electrode active material is mixed with the second solid electrolyte using a shaker.

10. The method of manufacturing an electrode element according to claim 6, wherein the positive electrode active material is mixed with the second solid electrolyte using a spatula.

11. The method of manufacturing an electrode element according to claim 6, further comprising:
preparing a mixture by mixing a conductive agent with the second solid electrolyte before mixing the positive electrode active material, on which the coating layer is formed, with the second solid electrolyte, wherein
the prepared mixture is mixed with the positive electrode active material on which the coating layer is formed.

12. The method of manufacturing an electrode element according to claim 6, wherein the first solid electrolyte is a lithium niobate, and the second solid electrolyte is a sulfide.

13. A lithium ion secondary battery comprising:
a positive electrode layer that contains the electrode element according to claim 1;
a negative electrode layer; and
a solid electrolyte layer that is arranged between the positive electrode layer and the negative electrode layer.
